(19) United States
(12) Patent Application Publication
(10) Pub. No.: US 2016/0342943 A1
(43) Pub. Date: Nov. 24, 2016

(54) Method and apparatus for causing of unlocking and locking of at least one door of a vehicle for a delivery

(71) Applicants: Ralph Wiechers, Mayschoß (DE); Matthias Busecke, Bonn (DE)

(72) Inventors: Ralph Wiechers, Mayschoß (DE); Matthias Busecke, Bonn (DE)

(73) Assignee: Deutsche Post AG, Bonn (DE)

(21) Appl. No.: 15/159,964

(22) Filed: May 20, 2016

(30) Foreign Application Priority Data
May 20, 2015 (DE) 10 2015 107 975.5

(51) Int. Cl. G06Q 10/08; G07C 9/00

(52) U.S. Cl. CPC G06Q 10/0833; G07C 9/00896; G07C 2009/0092

(57) ABSTRACT

The disclosure relates, inter alia, to a method for causing of unlocking and locking of at least one door of a vehicle for delivery of a shipment, particularly a package and/or a letter, into the vehicle. The method includes the steps of obtaining a piece of access authorisation information at a control apparatus; causing of the unlocking of the door of the vehicle, at least in part on the basis of the obtained piece of access authorisation information, by the control apparatus; obtaining one or more pieces of delivery event information, associated with a delivery event, at the control apparatus; and causing of the locking of the door of the vehicle by the control apparatus only if the obtained pieces of delivery event information are associated with one or more predetermined delivery events.

### CROSS-REFERENCE TO RELATED PATENT APPLICATIONS

This patent application claims priority to German Application No. 10 2015 107 975.5, filed May 20, 2015, the entire teachings and disclosure of which are incorporated herein by reference thereto.

### FIELD

Exemplary embodiments of the invention relate to a method for causing of unlocking and locking of at least one door of a vehicle for delivery of a shipment, particularly a package and/or a letter, into the vehicle, a computer program, a control apparatus, a vehicle, a system and a use.

### BACKGROUND

The delivery of a shipment into a vehicle of the shipment recipient by dint of depositing of the shipment in the interior of the vehicle is a form of delivery that is very convenient for the shipment recipient, since the shipment recipient does not have to receive the shipment in person. By way of example, the shipment can be delivered into the vehicle of the shipment recipient while it is parked in a company car park during the working hours of the shipment recipient. However, in order to deliver the shipment into the vehicle, the delivery agent needs to obtain access to the interior of the vehicle without the proper course of the delivery process at the vehicle being ensured by the personal presence of the shipment recipient, for example. Accordingly, there are great security concerns with regard to this form of delivery that have not been able to be removed by known methods and apparatuses to date.

### SUMMARY OF A FEW EXEMPLARY EMBODIMENTS OF THE INVENTION

The present invention has therefore taken on the task, inter alia, of overcoming these problems.

According to the invention, a method for causing of unlocking and locking of at least one door of a vehicle for delivery of a shipment, particularly a package and/or a letter, into the vehicle is disclosed, which comprises the following:
obtaining a piece of access authorisation information at a control apparatus,
causing of the unlocking of the door of the vehicle, at least in part on the basis of the obtained piece of access authorisation information, by the control apparatus,
obtaining one or more pieces of delivery event information, associated with a delivery event, at the control apparatus,
causing of the locking of the door of the vehicle by the control apparatus only if the obtained pieces of delivery event information are associated with one or more predetermined delivery events.

For example, the method according to the invention is performed at least in part by the control apparatus and/or by respective means of the control apparatus, for example a control apparatus of the vehicle.

According to the invention, a control apparatus is disclosed that comprises the following:
means configured to perform and/or control the method according to the invention or respective means for performing and/or controlling the steps of the method according to the invention (e.g. all steps that are not performed by a user).

For example, the means of the control apparatus according to the invention are configured to perform and/or to control the method according to the invention or the steps thereof (e.g. apart from the steps that are performed by a user). One or more of the steps of the method according to the invention can also be performed and/or controlled by the same means. By way of example, one or more of the means of the control apparatus may be formed at least in part by one or more processors.

For example, the control apparatus according to the invention comprises at least one processor and at least one memory that contains program code, wherein the memory and the program code are configured to prompt the control apparatus having the at least one processor to perform and/or to control at least the method according to the invention. In this case, either all steps of the method according to the invention can be controlled or all steps of the method according to the invention can be performed, or one or more steps are controlled and one or more steps are performed.

By way of example, a processor is intended to be understood to mean a control unit, a microprocessor, a microcontrol unit, such as a microcontroller, a digital signal processor (DSP), an application-specific integrated circuit (ASIC) or a field-programmable gate array (FPGA).

For example, the control apparatus according to the invention is a control apparatus for a vehicle, for example a control apparatus for controlling the unlocking and locking of at least one door of the vehicle for delivery of a shipment into the vehicle.

According to the invention, a vehicle is disclosed that comprises the following:
at least one door,
locking means configured to lock and unlock the door, and
a control apparatus according to the invention.

According to the invention, a system is disclosed that comprises the following:
a vehicle according to the invention, and
a portable delivery agent apparatus.

According to the invention, a computer program is disclosed that comprises the following: program instructions that cause a processor to perform and/or control the method according to the invention when the computer program runs on the processor.

By way of example, the computer program according to the invention may be distributable over a network, such as the Internet, a telephone or mobile radio network and/or a local area network. The computer program according to the invention may be at least in part software and/or firmware of a processor. It may equally be implemented at least in part as hardware. By way of example, the computer program according to the invention may be stored on a computer-readable storage medium, e.g. a touchable, magnetic, electrical, electromagnetic, optical and/or other kind of storage medium. By way of example, the storage medium may be part of the processor, for example a (nonvolatile or volatile) program memory and/or main memory of the processor or a portion thereof.

According to the invention, a use is disclosed that comprises the following:
use of a vehicle according to the invention and/or of a portable delivery agent apparatus for initiating one or more delivery events in order to prompt causing of the locking of a door of the vehicle according to the invention.

The properties of the method according to the invention, of the control apparatus according to the invention, of the vehicle according to the invention, of the system according to the invention, of the computer program according to the invention and of the use according to the invention are described—in part by way of example—below.

As disclosed above, the control apparatus according to the invention is a control apparatus for a vehicle, for example. By way of example, the control apparatus is a control apparatus that is installed in the vehicle at the factory, and controls a multiplicity of functions and/or means of the vehicle. However, it is also conceivable for the control apparatus to be retrofittable to the vehicle and, by way of example, to control only functions and means (e.g. locking means) of the vehicle in order to allow the delivery of the shipment into the vehicle.

By way of example, a control apparatus such as the control apparatus according to the invention is intended to be understood to mean an apparatus that controls the unlocking and/or opening and the locking and/or closing of at least one door of a vehicle. For example, control means of the control apparatus are configured to send a control signal, for example to locking means of the door, in order to prompt unlocking and/or opening of the door, for example, in order to allow access to an interior of the vehicle. For example, the control means of the control apparatus are additionally configured to send a control signal, for example to locking means of the door, in order to prompt locking and/or closing of the door, for example, in order to prevent access to an interior of the vehicle. Accordingly, by way of example, the causing of the unlocking and/or of the locking of the door of the vehicle is intended to be understood to mean the actuation of the locking means of the door by the control apparatus in order to prompt unlocking and/or locking of the door by the locking means of the door.

An example of locking means of the door is an electronically actuatable lock and/or an electronically actuatable locking unit. For example, the control means of the control apparatus according to the invention are configured to control such a lock and hence, by way of example, to be able to cause opening of the lock (i.e. unlocking of the door) and/or closing of the lock (i.e. locking of the door). By way of example, it is conceivable for the control apparatus according to the invention to comprise the locking means. However, the locking means of the door may also be separate from the control apparatus according to the invention.

By way of example, the causing of the unlocking of the door of the vehicle at least in part on the basis of the obtained piece of access authorisation information by the control apparatus is intended to be understood to mean that the unlocking of the door of the vehicle is caused at least in part in response to the obtainment of the piece of access authorisation information.

The obtainment of one or more pieces of delivery event information, associated with a delivery event, at the control apparatus is intended to be understood both as disclosure of the case in which a piece of delivery event information is obtained at the control apparatus and as disclosure of the case in which multiple pieces of delivery event information are obtained at the control apparatus. Where reference is made only to the plurality of pieces of delivery event information (i.e. multiple pieces of delivery event information) below (e.g. for reasons of readability), this is always intended to be understood as disclosure of both cases (i.e. a piece of delivery event information or multiple pieces of delivery event information).

The same also applies to the causing of the locking of the door of the vehicle only if the obtained pieces of delivery event information are associated with one or more predetermined delivery events. This is intended to be understood both as disclosure of the case in which the obtained pieces of delivery event information are associated with a predetermined delivery event and as disclosure of the case in which the obtained pieces of delivery event information are associated with multiple predetermined delivery events. Where reference is made only to the plurality of delivery events (i.e. multiple predetermined delivery events) below (e.g. for reasons of readability), this is always intended to be understood as disclosure of both cases (i.e. a predetermined delivery event or multiple predetermined delivery events).

Pieces of information (e.g. the piece of access authorisation information and/or the pieces of delivery event information) can be obtained at the control apparatus according to the invention by reception and/or by capture, for example.

For example, pieces of information (e.g. the piece of access authorisation information and/or the pieces of delivery event information) can be obtained at the control apparatus according to the invention by sensing of one or more events by sensing means of the control apparatus according to the invention, for example. For example, the control apparatus according to the invention comprises appropriate sensing means.

For example, pieces of information (e.g. the piece of access authorisation information and/or the pieces of delivery event information) can be obtained by receiving the piece of information on communication means of the control apparatus according to the invention. For example, the control apparatus according to the invention comprises appropriate communication means. By way of example, the communication means of the control apparatus according to the invention are configured to use a communication connection to communicate with a portable delivery agent apparatus and/or with a central remote monitoring apparatus indirectly (e.g. via communication means of the vehicle) and/or directly and to send and/or receive pieces of information. An example of such a communication means is a communication interface. For example, the communication means of the control apparatus according to the invention comprise a communication interface for a wireless and/or wired communication technology.

An example of a wireless communication technology is a local radio network technology such as radio frequency identification (RFID) and/or near field communication (NFC) and/or Bluetooth (e.g. Bluetooth version 2.1 and/or 4.0) and/or wireless local area network (WLAN). By way of example, RFID and NFC are specified according to ISO standards 18000, 11784/11785 and ISO/IEC standard 14443-A and 15693. The Bluetooth specifications are currently available on the Internet at www.bluetooth.org. For example, WLAN is specified in the standards of the IEEE 802.11 family. A further example of a wireless communication technology is a regional radio network technology, such as for example a mobile radio technology, for example Global System for Mobile Communications (GSM) and/or Universal Mobile Telecommunications System (UMTS) and/or Long Term Evolution (LTE). The GSM, UMTS and LTE specifications are maintained and developed by the 3rd Generation Partnership Project (3GPP) and are currently available on the Internet at www.3gpp.com, inter-alia.

By way of example, the portable delivery agent apparatus is a portable electronic appliance and/or a portable electronic unit. By way of example, the delivery agent apparatus is configured to communicate with the communication means of the control apparatus according to the invention indirectly (e.g. via communication means of the vehicle) and/or directly, for example to communicate a piece of access authorisation information and/or one or more pieces of delivery event information to the communication means of the control apparatus according to the invention. For example, the delivery agent apparatus can comprise appropriate communication means, for example an analogue circuit for sending and receiving (also called a transceiver), a circuit (e.g. a digital circuit and/or a processor) and a memory (for example an EEPROM—Electrically Erasable Programmable Read-Only Memory). An example of a delivery agent apparatus is a user appliance such as a mobile telephone, a personal digital assistant (PDA), a media player (e.g. an iPod) and/or a navigation appliance, for example. A further example of a delivery agent apparatus is, for example, a delivery agent appliance of a delivery service, such as a hand-held scanner, for example the Dolphin 99EX mobile computer from the company Honeywell. A further example of a delivery agent apparatus is, for example, a “tag”, such as an RFID or NFC tag, for example a MiFARE DESFire from NXP.

By way of example, the remote monitoring apparatus is one or more servers, for example servers of a vehicle manufacturer and/or of a delivery service. By way of example, the remote monitoring apparatus is configured to communicate with the communication means of the control apparatus according to the invention indirectly (e.g. via communication means of the vehicle) and/or directly, for example to communicate a piece of access authorisation information and/or one or more pieces of delivery event information to the communication means of the control apparatus according to the invention. For example, the remote monitoring apparatus can comprise appropriate communication means. By way of example, a remote monitoring apparatus of a delivery service monitors the proper course of one or more deliveries, arranges one or more deliveries and provides the pieces of information (e.g. pieces of access authorisation information) that are necessary for the deliveries. By way of example, a remote monitoring apparatus of a vehicle manufacturer monitors the operation and position of one or more vehicles and controls means of one or more vehicles (e.g. in order to remotely maintain, activate, deactivate, unlock and/or lock the vehicles).

By way of example, a delivery event is intended to be understood to mean an event that is initiated during the delivery process and that is able to be sensed by appropriate sensing means. By way of example, a piece of delivery event information is intended to be understood as associated with a delivery event if the piece of delivery event information indicates that the delivery event has been sensed, for example has been sensed by appropriate sensing means.

Preferably, the predetermined delivery events are initiated by an action by the delivery agent during the delivery process on the vehicle. By way of example, the predetermined delivery event or the predetermined delivery events are chosen such that the initiation of the predetermined delivery event or of the predetermined delivery events has at least a high probability of allowing inference of the completion or the abortion of the delivery process on the vehicle. Since the locking of the door of the vehicle is caused only if the obtained pieces of delivery event information are associated with one or more predetermined delivery events, it is therefore possible to ensure that the door is automatically locked if there is at least a high probability (e.g. more than 50%) of the delivery process on the vehicle having been aborted and/or completed. So long as the delivery process on the vehicle has at least a high probability (e.g. more than 50%) of still being performed, the door remains unlocked, however. This is advantageous, by way of example, in order to prevent the door from being locked during the delivery process on the vehicle, and the delivery process not being able to be finished as a result. At the same time, this can prevent the door from remaining unlocked even after the abortion or completion of the delivery process on the vehicle.

Therefore, the present invention allows the delivery process on the vehicle to be monitored and security to be increased.

Further advantages of the disclosed invention are described below on the basis of exemplary embodiments of the method, the control apparatus, the vehicle, the system, the computer program and the use, the disclosure of which is intended to apply to the respective categories (method, apparatus, system, computer program, use) in equal measure.

According to one exemplary embodiment of the invention, the method additionally comprises the checking of whether the one or more obtained pieces of delivery event information are associated with the one or more predetermined delivery events. For example, checking involves determination of whether the one or more obtained pieces of delivery event information indicate that the one or more predetermined delivery events have been sensed (e.g. have been sensed by sensing means of the control apparatus and/or of the vehicle). For example, the control apparatus comprises appropriate checking means.

For example, the locking of the door of the vehicle is caused by the control apparatus only if the result of the check is that the obtained pieces of delivery event information are associated with one or more predetermined delivery events (e.g. if the result of the check is that the obtained pieces of delivery event information indicate that the multiple predetermined delivery events have been sensed).

According to one exemplary embodiment of the invention, at least one of the predetermined delivery events is opening and/or closing of the door, depositing of the shipment in an interior of the vehicle, a portable delivery agent apparatus situated in the surroundings of the control apparatus, a user input for completion of the delivery process by the delivery agent on a portable delivery agent apparatus and/or exceeding of a predetermined duration of the delivery process since the causing of the unlocking of the door of the vehicle and/or since the obtainment of a piece of delivery event information.

In order to be able to deliver the shipment into the vehicle (i.e. to be able to deposit the shipment in the interior of the vehicle), the delivery agent must inevitably open and close the door. The opening and/or closing of the door is therefore an event that is inevitably initiated by the delivery agent during the delivery process. The sensing of this delivery event therefore allows monitoring of some essential actions by the delivery agent during the delivery process on the vehicle. Thus, the opening of the door allows inference of the beginning of the delivery process on the vehicle, for example, and the closing of the door allows inference of the completion of the delivery process on the vehicle, for example. The opening and/or closing of the door can be sensed by a door opening sensor, for example. Door opening sensors are provided in most vehicles for the purpose checking whether the doors of the vehicle are closed properly.

The depositing of the shipment in the interior of the vehicle is also an event that is inevitably initiated by the delivery agent during the delivery process on the vehicle. The sensing of this delivery event therefore allows monitoring of an essential action by the delivery agent during the delivery process on the vehicle. The depositing of the shipment in the interior of the vehicle can be sensed by a weight sensor, a load sensor, a camera or an ultrasonic sensor, for example. For example, a weight sensor can sense a change in the weight bearing down on a surface of the vehicle when the shipment is deposited on the surface of the vehicle. Such weight sensors are provided in most vehicles as seat occupancy sensors, for example. By way of example, a load sensor can sense a change in the load on the vehicle when the shipment is deposited in the interior of the vehicle. Load sensors are used in vehicles for the purpose of automatic headlamp levelling, for example. A camera or an ultrasonic sensor is provided in many vehicles as part of the alarm system for monitoring the interior. Such a camera or such an ultrasonic sensor can sense a change in the interior of the vehicle as a result of the depositing of the shipment in the interior of the vehicle.

The fact that a portable delivery agent apparatus is situated in the surroundings of the control apparatus and/or of the vehicle is able to be sensed by communication means of the control apparatus and/or of the vehicle (e.g. by a communication interface for a local radio network technology), for example. For example, it is assumed that the portable delivery agent apparatus is situated in the surroundings of the control apparatus and/or of the vehicle so long as the delivery agent apparatus is situated within the range of the communication means for a local radio network technology of this kind. By way of example, the surroundings of the control apparatus and/or of the vehicle are determined by the range of the communication means. The range of a communication signal according to a radio network technology of this kind is limited, by way of example, to less than 250 m, by way of example less than 100 m, preferably less than 50 m, particularly preferably to less than 20 m. An example of such a communication signal is an RFID signal, a Bluetooth signal, an NFC and/or a WLAN signal.

By way of example, the communication means sense that a portable delivery agent apparatus is situated in the surroundings of the control apparatus and/or of the vehicle by receiving a communication signal (e.g. an RFID signal, a Bluetooth signal, an NFC and/or a WLAN signal) from the delivery agent apparatus. For example, the portable delivery agent apparatus transmits such a communication signal repeatedly (e.g. periodically) at least during the delivery process on the vehicle. It is also conceivable for the portable delivery agent apparatus to transmit such a communication signal in response to a request communication signal transmitted by the communication means of the control apparatus and/or of the vehicle. So long as the communication signal is receivable by communication means for a wireless local communication technology of the control apparatus and/or of the vehicle, the delivery process on the vehicle has at least a high probability of not being complete and there is at least a high probability of a delivery agent being situated in the surroundings of the vehicle. As soon as the communication signal is no longer receivable by communication means for a wireless local communication technology of the control apparatus and/or of the vehicle, the delivery process on the vehicle has at least a high probability of being complete or aborted.

By way of example, a user input for completion of the delivery process by the delivery agent on a portable delivery agent apparatus is able to be sensed by sensing means of the delivery agent apparatus, such as user input means (e.g. a keypad). For example, the delivery agent confirms the completion of the delivery process by dint of a user input on the portable delivery agent apparatus.

The exceeding of a predetermined duration of the delivery process on the vehicle since the causing of the unlocking of the door of the vehicle and/or since the obtainment of a piece of delivery event information (e.g. a piece of delivery event information associated with the reception of a communication signal from a portable delivery agent apparatus by communication means of the control apparatus and/or of the vehicle) has a high probability of allowing inference of the completion and/or the abortion of the delivery process on the vehicle, for example. By way of example, the predetermined duration corresponds to an average duration or to an expected maximum duration of a delivery process on the vehicle or to an expected maximum length of time before the next delivery event. The exceeding of the predetermined duration can be sensed using a clock and/or a timer function, for example.

According to one exemplary embodiment of the invention, the unlocking is caused only if multiple pieces of delivery event information are obtained and the obtained pieces of delivery event information are associated with multiple predetermined delivery events and/or with one or more predetermined delivery event combinations. By way of example, a predetermined delivery event combination is a combination of two different delivery events, so that the unlocking in this example is caused only if at least two pieces of delivery event information are obtained and one of the obtained pieces of delivery event information is associated with one of the two predetermined delivery events and another of the obtained pieces of delivery event information is associated with the other of the two predetermined delivery events. Cases are also conceivable in which a predetermined delivery event combination is a combination of more than two different delivery events, for example three, four or five different delivery events. In addition, cases are also conceivable in which different delivery event combinations are predetermined, the unlocking in these cases being caused only if multiple pieces of delivery event information are obtained and the obtained pieces of delivery event information are associated at least with the delivery events of one of the multiple predetermined delivery event combinations, for example.

Alternatively or additionally, one or more orders for the predetermined delivery events and/or delivery event combinations may be predetermined, so that the unlocking is caused only if the pieces of delivery event information are obtained in one of the predetermined orders (e.g. in one of the predetermined orders of the predetermined delivery events), for example.

According to one exemplary embodiment of the invention, at least one of the predetermined delivery events is a delivery event that is able to be sensed by sensing means of the vehicle and/or of a portable delivery agent apparatus. By way of example, the sensing means in the vehicle also used for other purposes, such as for sensing seat occupancy and/or for interior monitoring. This is advantageous, by way of example, in order to avoid the need to provide additional sensing means in the control apparatus and/or the vehicle.

According to one exemplary embodiment of the apparatus, the method additionally comprises the sensing of at least one of the predetermined delivery events. For example, the method additionally comprises the production of the piece of delivery event information associated with this at least one sensed delivery event.

For example, the at least one of the predetermined delivery events is sensed by sensing means of the vehicle, of the control apparatus and/or of a portable delivery agent apparatus. By way of example, the sensing means are configured to sense the at least one of the predetermined delivery events. For example, the sensing means are additionally configured to produce the piece of delivery event information associated with this at least one sensed delivery event.

An example of sensing means is a sensor such as a camera, a door opening sensor, an ultrasonic sensor, a load sensor and/or a weight sensor, for example. A further example of sensing means is a measuring unit such as a clock and/or timer function. A further example of sensing means is a user input means such as a keypad. A further example of sensing means is a communication means such as a communication interface.

If the sensing means are not part of the control apparatus, then the piece of delivery event information associated with the at least one sensed delivery event is communicated by the sensing means to communication means of the control apparatus, for example. For example, the sensing means are in this case configured to produce the piece of delivery event information associated with the at least one sensed delivery event and to communicate it to communication means of the control apparatus.

According to one exemplary embodiment of the invention, the piece of access authorisation information and/or the pieces of delivery event information are received at the control apparatus and/or sent by the control apparatus via one or more wireless communication connections. For example, the control apparatus comprises communication means that are configured to receive and/or to send pieces of information (e.g. the piece of access authorisation information and/or the pieces of delivery event information) via one or more wireless communication connections indirectly and/or directly.

For example, the communication means of the control apparatus are configured to receive and/or to send pieces of information (e.g. the piece of access authorisation information and/or the pieces of delivery event information) directly via one or more wireless communication connections. In this case, the communication means of the control apparatus are a communication interface for one or more wireless communication technologies, for example.

Alternatively or additionally, the communication means of the control apparatus may also be configured to receive and/or to send pieces of information (e.g. the piece of access authorisation information and/or the pieces of delivery event information) indirectly (e.g. via communication means of the vehicle) via one or more wireless communication connections. In this case, the communication means of the control apparatus are, by way of example, a vehicle interface such as an interface of a vehicle bus and/or a vehicle diagnosis interface. For example, the pieces of information are received directly by communication means of the vehicle via one or more wireless communication connections and then communicated (e.g. via a vehicle diagnosis interface and/or a vehicle bus) to the communication means of the control apparatus, and/or communicated by the communication means of the control apparatus to the communication means of the vehicle (e.g. via a vehicle diagnosis interface and/or via a vehicle bus) and then sent by communication means of the vehicle via one or more wireless communication connections. An example of a vehicle bus is a controller area network bus (CAN bus), a K-line bus, an L-line bus and/or an IDB-1394 bus. An example of a vehicle diagnosis interface is a K-line interface, an L-line interface and/or an on-board diagnosis interface (OBD interface).

For example, the control apparatus is connectable and/or connected to a remote monitoring apparatus via at least one of the wireless communication connections. By way of example, the control apparatus can use this at least one of the wireless communication connections to communicate with the remote monitoring apparatus. For example, this communication connection can be used to receive pieces of information from the remote monitoring apparatus at the control apparatus and/or to send said pieces of information from the control apparatus to the remote monitoring apparatus.

For example, the control apparatus is connectable and/or connected to a delivery agent apparatus via at least one of the wireless communication connections. By way of example, the control apparatus can use this at least one of the wireless communication connections to communicate with the delivery agent apparatus. For example, this communication connection can be used to receive pieces of information from the delivery agent apparatus at the control apparatus and/or to send said pieces of information from the control apparatus to the delivery agent apparatus.

For example, at least one of the wireless communication connections is a communication connection via a mobile radio network. For example, the control apparatus is connected to the remote monitoring apparatus via this communication connection via a mobile radio network.

For example, at least one of the wireless communication connections is a communication connection via a local radio network. For example, the control apparatus is connected to the delivery agent apparatus via this communication connection via a local radio network.

Cases are also conceivable in which the control apparatus is connected and/or connectable to the remote monitoring apparatus but not to the delivery agent apparatus. For example, in these cases, pieces of information can be received from the remote monitoring apparatus at the control apparatus via a wireless communication connection. For example, the communication means of the control apparatus are configured to receive pieces of information (e.g. the piece of access authorisation information and/or the pieces of delivery event information) from the remote monitoring apparatus (e.g. but not from the delivery agent apparatus) and/or to send said pieces of information to the remote monitoring apparatus (e.g. but not to the delivery agent apparatus) indirectly or directly via one or more wireless communication connections (e.g. via a wireless communication connection via a mobile radio network). In these cases, the delivery agent apparatus can communicate with the control apparatus only via the remote monitoring apparatus, for example. This is advantageous, by way of example, in order to allow monitoring of the communication between the control apparatus and the delivery agent apparatus and to prevent abuse of the delivery agent apparatus, for example by an unauthorised party that wishes to gain access to the vehicle.

For example, the system additionally comprises one or more delivery agent apparatuses and/or one or more remote monitoring apparatuses.

According to one exemplary embodiment of the invention, the method additionally comprises:
deciding about whether access can be granted for the delivery into the vehicle, at least in part on the basis of the obtained piece of access authorisation information, and
causing of the unlocking of the door of the vehicle only if it has been decided that access can be granted.

For example, the piece of access authorisation information is communicated from a delivery agent apparatus to the control apparatus (e.g. to communication means of the control apparatus). Alternatively or additionally, it is also conceivable for the piece of access authorisation information to be communicated from a remote monitoring apparatus to the control apparatus (e.g. to communication means of the control apparatus). As disclosed above, the piece of access authorisation information can be communicated to the control apparatus via a wireless communication connection, for example.

By way of example, deciding about whether access can be granted is intended to be understood to mean that a check is performed to determine whether the obtained piece of access authorisation information authorises access (e.g. by the control apparatus). For example, the control apparatus comprises checking means that are configured to check whether the obtained piece of access authorisation information authorises access.

The piece of access authorisation information includes one or more access authorisation parameters, for example. This or these may be, by way of example, an (in particular explicit) identifier for the control apparatus and/or the vehicle, an (in particular explicit) identifier for the piece of access authorisation information itself, pieces of temporal validity information (e.g. in the form of a Not Before date“, a Not After date”, a “start time for the day” and an “end time for the day”, which indicate on what days and at what time of day access can be granted for the delivery, for example from 27.3.2014 00:00:00 to 28.3.2014 23:59:59), a spatial piece of validity information (e.g. in the form of a radius around a delivery coordinate and/or delivery position within which access can be granted), an upper limit for the permitted uses of the piece of access authorisation information in order to gain access, and a piece of information concerning the extent to which access can be granted (that is to say, by way of example, whether all doors of the vehicle can be opened, or just one or a particular group).

At least one predefined set (e.g. all, or just some) of the access authorisation parameters have respective reference pieces of information checked to determine whether they authorise access in each case.

By way of example, the identifier for the control apparatus, as an access authorisation parameter, can have an identifier for the control apparatus, which is stored in the control apparatus, checked and, in the event of a match, it can be established that this access authorisation parameter authorises access. This is advantageous, by way of example, if the control apparatus is a control apparatus from a multiplicity of control apparatuses, in order to ensure that the piece of access authorisation information only authorises access for the control apparatus having the corresponding identifier.

By way of example, the pieces of temporal validity information, as access authorisation parameters, can have a piece of temporal information (e.g. date and time of day), obtained from a clock of the control apparatus, checked, for example such that a delivery period defined by the pieces of validity information must include the present time according to the clock of the control apparatus in order for access to be able to be granted. By way of example, the delivery period may be a delivery period predetermined by the recipient of the shipment and/or the owner of the vehicle. This is advantageous, by way of example, in order to restrict the delivery period, so that the owner of the vehicle can remove items of value from the vehicle for this period, for example.

By way of example, the spatial pieces of validity information, as access authorisation parameters, can have a piece of spatial information (e.g. present or last coordinates and/or position), obtained at the control apparatus from a positioning sensor of the control apparatus and/or of the vehicle, checked, for example such that a delivery area (e.g. a radius around a delivery position) defined by the pieces of validity information must include the present coordinates and/or the present position of the control apparatus and/or of the vehicle in order for access to be able to be granted. By way of example, the delivery area may be a delivery area predetermined by the recipient of the shipment and/or the owner of the vehicle. By way of example, the positioning sensor may be a positioning sensor of a vehicle navigation system, e.g. a Global Positioning System sensor (GPS sensor). This is advantageous, by way of example, in order to restrict the delivery area.

For example, access is thus granted if it has been established for at least one determined set of the access authorisation parameters that the respective reference piece of information of said access authorisation parameters authorises access in the control apparatus. If it is decided that access can be granted, then, by way of example, an appropriate control signal is output, for example to the locking means (e.g. the lock). Otherwise, by way of example, a visual and/or audible alarm and/or a warning are output and/or an appropriate piece of information is communicated to a remote monitoring apparatus.

For example, access is granted by dint of unlocking of the at least one door of the vehicle being caused (e.g. by the control apparatus). As described above, the control means of the control apparatus may be configured to control the lock and hence, by way of example, to be able to cause opening of the lock (i.e. unlocking of the door) and/or closing of the lock (i.e. locking of the door).

According to one exemplary embodiment of the invention, the piece of access authorisation information authorises access for the delivery into the vehicle. For example, the piece of access authorisation information authorises exclusively access for the delivery into the vehicle.

According to one exemplary embodiment of the invention, the piece of access authorisation information has a limited temporal and/or spatial validity.

According to one exemplary embodiment of the invention, the piece of access authorisation information is valid only for a limited number of accesses. For example, the piece of access authorisation information is valid only for a limited number of accesses to the vehicle and/or further vehicles. For example, the piece of access authorisation information is valid only for a single access to the vehicle.

According to one exemplary embodiment of the invention, the vehicle is a land vehicle, for example a motor vehicle such as a heavy goods vehicle or a car, particularly preferably a car (e.g. an automobile).

According to one exemplary embodiment of the invention, the door is a boot door of the vehicle.

According to one exemplary embodiment of the invention, exclusively the unlocking of the boot door of the vehicle is caused.

According to one exemplary embodiment of the invention, the method additionally comprises:
opening of the door and/or causing of the opening of the door, and/or
closing of the door and/or causing of the closing of the door.

For example, the door can be opened and/or closed by the delivery agent.

Alternatively or additionally, the door can also be opened and/or closed by opening and closing means of the door, for example. For example, control means of the control apparatus are configured to send a control signal, for example to opening and closing means of the door, for example in order to prompt opening and/or closing of the door. This is advantageous, by way of example, in order to ensure that the door can also actually be closed following completion of the delivery process on the vehicle (e.g. if the delivery agent forgets to close the door).

By way of example, it is conceivable for the control apparatus to comprise the opening and closing means of the door. However, the opening and closing means of the door may also be separate from the control apparatus.

An example of such opening and closing means is an electronically actuatable, motor-driven door opener and closer. For example, the control means of the control apparatus according to the invention are configured to control such a door opener and closer and hence, by way of example, to be able to cause opening of the door and/or closing of the door.

According to one exemplary embodiment of the invention, the method additionally comprises initiating the delivery events (e.g. by the delivery agent). As disclosed above, the predetermined delivery events are initiated preferably by an action by the delivery agent during the delivery process on the vehicle.

Further advantageous exemplary refinements of the invention can be found in the detailed description that follows for a few exemplary embodiments of the present invention, particularly in conjunction with the figures. The figures accompanying the application are intended to be used only for the purpose of clarification, however, rather than for determining the scope of protection of the invention. The accompanying drawings are not necessarily to scale and are intended merely to reflect the general concept of the present invention by way of example. In particular, features included in the figures are in no way intended to be regarded as a necessary part of the present invention.

### BRIEF DESCRIPTION OF THE SEVERAL VIEWS OF THE DRAWING

In the drawings:

FIG. 1 shows a block diagram of the electronic components of an exemplary embodiment of a control apparatus according to the invention;

FIGS. 2a and 2b each show a block diagram of an exemplary embodiment of a system according to the invention;

FIGS. 3a and 3b each show a flowchart for an example of a method according to the invention; and

FIG. 4 shows a flowchart for an example of a use according to the invention.

### DETAILED DESCRIPTION OF THE INVENTION

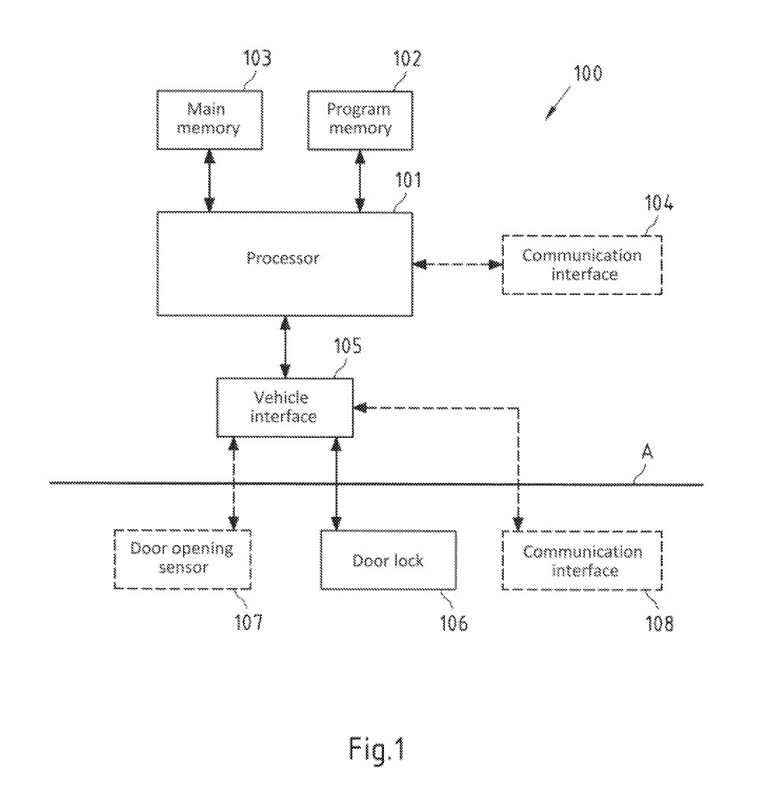

FIG. 1 is a block diagram of an exemplary embodiment of the control apparatus 100 according to the invention.

Processor 101 of the control apparatus 100 is particularly in the form of a microcontroller or microprocessor. Processor 101 executes program instructions that are stored in program memory 102, and stores interim results or the like in main memory 103, for example. For example, program memory 102 is a nonvolatile memory such as a flash memory, a magnetic memory, an EEPROM memory, a persistent memory such as a ROM memory and/or an optical memory. Main memory 103 is a volatile or nonvolatile memory, for example, particularly a random access memory (RAM) such as a static RAM memory (SRAM), a dynamic RAM memory (DRAM), a ferroelectric RAM memory (FeRAM) and/or a magnetic RAM memory (MRAM).

Preferably, program memory 102 and main memory 103 are arranged together with processor 101 in one module.

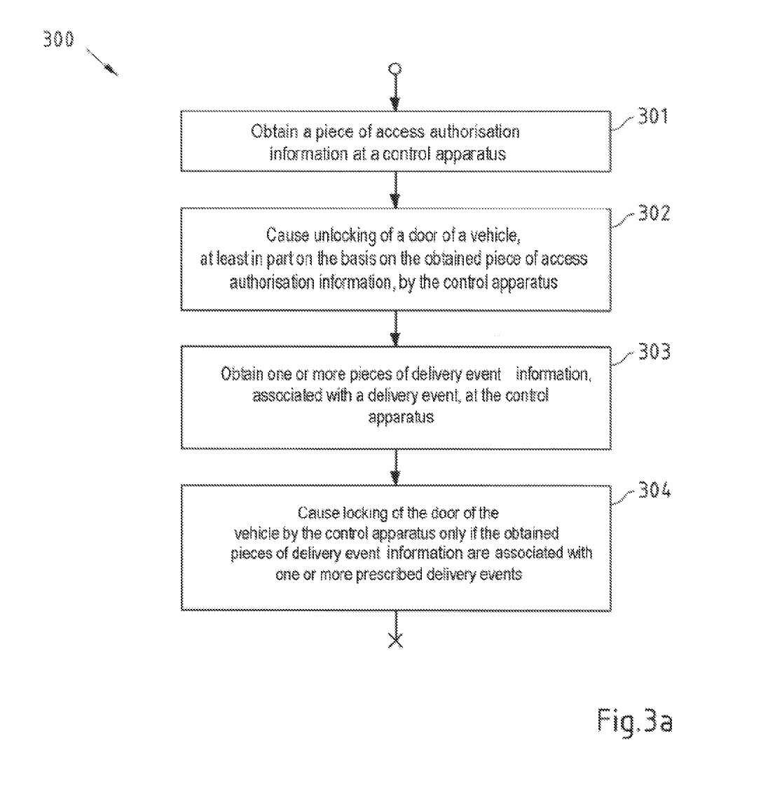

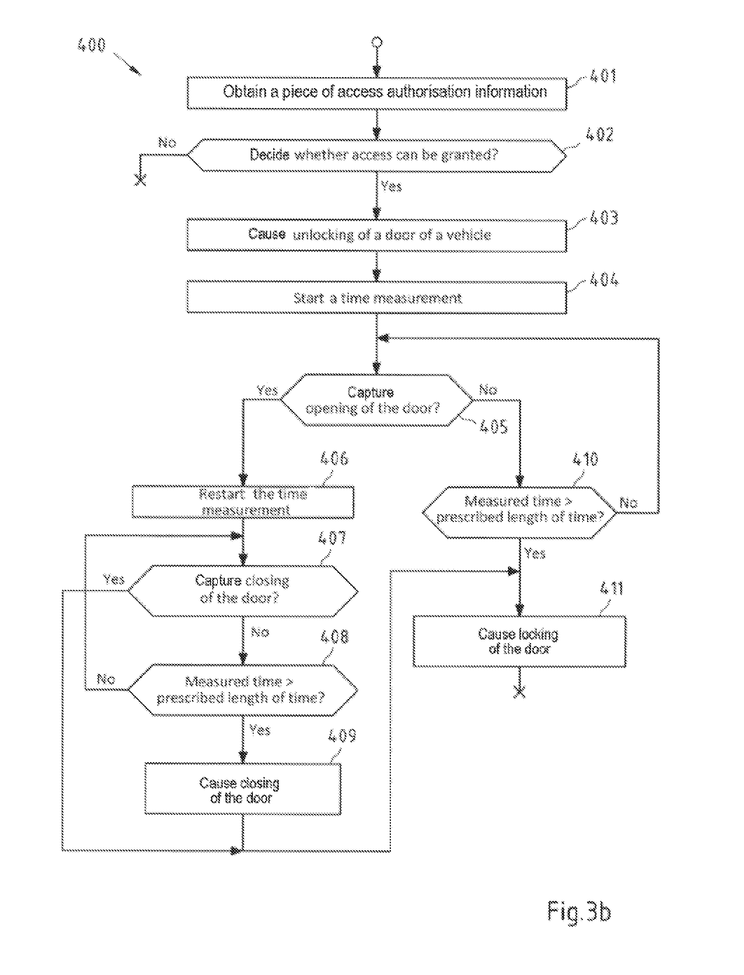

By way of example, program memory 102 stores program instructions that prompt the processor 101, when it executes the program instructions, to perform and/or to control the methods shown in FIGS. 3a and 3b at least in part.

For example, the optional wireless communication interface 104 is configured to communicate according to one or more wireless communication technologies. It is assumed by way of example below that the wireless communication interface 104 supports communication via a local radio network and a mobile radio network. For example, the wireless communication interface 104 is formed at least in part by a transceiver for the local radio network technology, a transceiver for the mobile radio technology and one or more antennas. As disclosed above, an example of a local radio network technology is RFID, NFC, Bluetooth and/or WLAN, and an example of a mobile radio technology is GSM, UMTS and/or LTE. Optionally, the wireless communication interface 104 can support only one of these wireless communication technologies or further wireless communication technologies.

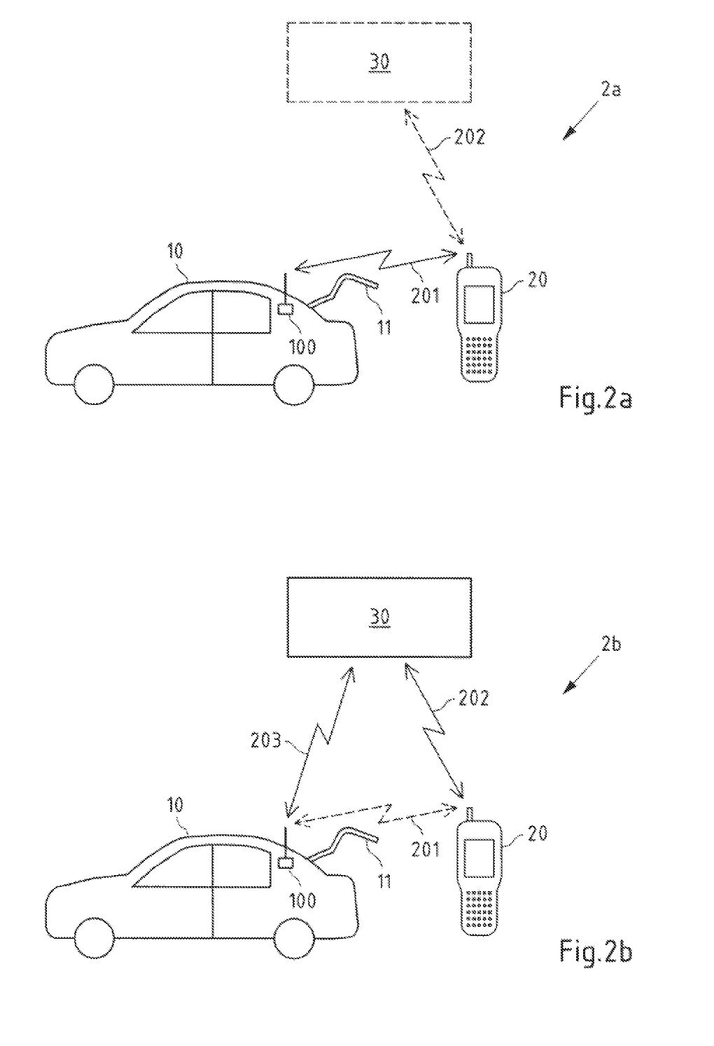

By way of example, the processor 101 can use the wireless communication interface 104 to communicate with other apparatuses such as a remote monitoring apparatus (e.g. the remote monitoring apparatus 30 in FIG. 2b) and/or a delivery agent apparatus (e.g. the delivery agent apparatus 20 in FIGS. 2a and 2b). By way of example, processor 101 is operatively connected to the wireless communication interface 104. By way of example, the wireless communication interface 104 can receive or request pieces of information from other apparatuses and forward said pieces of information to processor 101 and/or can receive pieces of information from processor 101 and send said pieces of information to other apparatuses. For example, processor 101 controls the communication interface 104 at least in part.

Via the vehicle interface 105, processor 101 is additionally connectable to means of a vehicle. By way of example, the vehicle interface 105 is a vehicle diagnosis interface and/or an interface of a vehicle bus. By way of example, processor 101 is operatively connected to vehicle interface 105. By way of example, the vehicle interface 105 is configured to use a corresponding interface of a vehicle (e.g. of the vehicle 10 in FIGS. 2a and 2b) to connect to a vehicle bus of the vehicle and to use the vehicle bus to communicate with means of the vehicle (e.g. door lock 106, door opening sensor 107 and/or wireless communication interface 108). For example, the vehicle interface 105 can receive or request pieces of information from means of the vehicle (e.g. door lock 106, door opening sensor 107 and/or wireless communication interface 108) and forward said pieces of information to processor 101 and/or can receive pieces of information from processor 101 and send said pieces of information to means of the vehicle (e.g. door lock 106, door opening sensor 107 and/or wireless communication interface 108). For example, processor 101 controls the vehicle interface 105 at least in part.

The door lock 106 of the optional door opening sensor 107 and the optional wireless communication interface 108 are not part of the control apparatus 100 but rather are part of the vehicle (e.g. the vehicle 10 in FIGS. 2a and 2b), for example. The boundary between control apparatus 100 and the vehicle is indicated in FIG. 1 by the line A running above the door lock 106, the sensor 107 and the wireless communication interface 108. The processor 101 can communicate with the door lock 106, the door opening sensor 107 and the wireless communication interface 108 via the vehicle interface 105 and can control these means of the vehicle, at least in part, via the vehicle interface 105.

By way of example, the door lock 106 is an electronically actuatable lock. The door lock 106 is a lock of a door of the vehicle (e.g. a lock of the door 11 of the vehicle 10 in FIGS. 2a and 2b), for example. Besides door lock 106, the processor 101 may be connected via the vehicle interface 105 to further door locks of the vehicle (e.g. of the vehicle 10 in FIGS. 2a and 2b).

For example, the optional door opening sensor 107 is a door opening sensor of the door with the door lock 106 of the vehicle (e.g. a door opening sensor of the door 11 of the vehicle 10 in FIGS. 2a and 2b). By way of example, the door opening sensor 107 is configured to sense whether the door is open or closed, and to produce corresponding pieces of event information. For example, the processor 101 receives corresponding pieces of event information regarding whether the door is open and/or is closed from the door opening sensor 107 via the vehicle interface 105. Besides door opening sensor 107, the processor 101 may be connected via the vehicle interface 105 to further sensors of the vehicle (e.g. of the vehicle 10 in FIGS. 2a and 2b). An example of such further sensors are a weight sensor, a seat occupancy sensor and/or a load sensor.

The optional wireless communication interface 108 is configured like the optional application interface 104, for example, and supports communication via a local radio network and a mobile radio network. Optionally, the wireless communication interface 108 can support only one of these wireless communication technologies or further wireless communication technologies.

By way of example, the processor 101 is operatively connected to the wireless communication interface 108 via the vehicle interface 105. By way of example, the processor 101 can use the wireless communication interface 108 to communicate with other apparatuses such as a remote monitoring apparatus (e.g. the remote monitoring apparatus 30 in FIG. 2b) and/or a delivery agent apparatus (e.g. the delivery agent apparatus 20 in FIGS. 2a and 2b). By way of example, the wireless communication interface 108 can receive or request pieces of information from other apparatuses and forward said pieces of information to processor 101 via the vehicle interface 105 and/or can receive pieces of information from processor 101 and send said pieces of information to other apparatuses via the vehicle interface 105. For example, processor 101 controls the communication interface 108 at least in part. The wireless communication interface 108 may be provided as an alternative or in addition to the wireless communication interface 104.

FIG. 2a shows a block diagram of an exemplary embodiment of the system 2a according to the invention. The system 2a comprises a vehicle 10 and a portable delivery agent apparatus 20. The vehicle 10 is a car and comprises the control apparatus 100 according to the invention and a boot door 11. The control apparatus 100 and the delivery agent apparatus 20 are connected to one another via a communication connection 201. It is assumed by way of example below that the communication connection 201 comprises a wireless communication connection via a local radio network.

By way of example, the delivery agent apparatus 20 is an electronic appliance of the delivery agent from a delivery service who is charged with the delivery of the shipment into the vehicle. An example of the delivery agent apparatus 20 is, for example, a delivery agent appliance of a delivery service, such as a hand-held scanner, for example the Dolphin 99EX mobile computer from the company Honeywell. A further example of a delivery agent apparatus is, for example, a “tag”, such as an RFID or NFC tag, for example a MiFARE DESFire from NXP.

By way of example, the optional remote monitoring apparatus 30 is a remote monitoring apparatus of a vehicle manufacturer and/or of a delivery service. By way of example, a remote monitoring apparatus of a delivery service monitors the proper course of one or more deliveries (e.g. by logging and evaluating received pieces of delivery event information), arranges one or more deliveries and provides the pieces of information (e.g. pieces of access authorisation information) that are necessary for the deliveries. By way of example, a remote monitoring apparatus of a vehicle manufacturer monitors the operation and position of one or more vehicles and controls means of one or more vehicles (e.g. in order to remotely maintain, activate, deactivate, unlock and/or lock the vehicles).

As disclosed above, the delivery agent apparatus 20 is connected to the control apparatus 100 via the communication connection 201 in system 2a. By way of example, the delivery agent apparatus 20 is configured, in system 2a, to communicate with the communication interface 104 and/or the communication interface 108 of the control apparatus 100 via the communication connection 201, for example to send a piece of access authorisation information and/or one or more pieces of delivery event information to the control apparatus 100 and/or to receive said piece(s) of information from the control apparatus 100.

Optionally, the delivery agent apparatus 20 is additionally connected to the remote monitoring apparatus 30 via the communication connection 202 in system 2a. It is assumed by way of example below that the communication connection 202 comprises a wireless communication connection via a mobile radio network. By way of example, the delivery agent apparatus 20 can use the communication connection 202 to send pieces of information (e.g. pieces of delivery event information) to the remote monitoring apparatus 30 and/or to receive pieces of information (e.g. pieces of access authorisation information) from the remote monitoring apparatus 30.

The communication connections 201 and 202 are shown in FIG. 2a as wireless communication connections by way of example. However, it is also conceivable, by way of example, for the communication connections 201 and/or 202 not to be exclusively wireless communication connections, for example at least one of the communication connections 201 and/or 202 comprises at least one wired communication connection and at least one wireless communication connection.

FIG. 2b shows a block diagram of an exemplary embodiment of the system 2b according to the invention. Besides the vehicle 10 and the delivery agent apparatus 20, the system 2b comprises a remote monitoring apparatus 30. The delivery agent apparatus 20 and the remote monitoring apparatus 30 are connected to one another via a communication connection 202 in system 2b. In addition, the remote monitoring apparatus 30 and the control apparatus 100 are connected to one another via a communication connection 203 in system 2b. It is assumed by way of example below that the communication connections 202 and 203 each comprise a wireless communication connection via a mobile radio network.

By way of example, the remote monitoring apparatus 30 is configured, in system 2b, to communicate with the communication interface 104 and/or the communication interface 108 of the control apparatus 100 via the communication connection 203, for example to send a piece of access authorisation information and/or one or more pieces of delivery event information to the control apparatus 100 and/or to receive said piece(s) of information from the control apparatus 100.

In addition, the delivery agent apparatus 20 is connected to the remote monitoring apparatus 30 via the communication connection 202 in system 2b. By way of example, the delivery agent apparatus 20 can use the communication connection 202 to send pieces of information (e.g. pieces of delivery event information) to the remote monitoring apparatus 30 and/or to receive pieces of information (e.g. pieces of access authorisation information) from the remote monitoring apparatus 30. By way of example, the delivery agent apparatus 20 can use the remote monitoring apparatus 30 to communicate with the control apparatus 100.

The communication connection 201 is merely optional in system 2b, and not necessarily present.

The communication connections 201, 202 and 203 are shown in FIG. 2b as wireless communication connections by way of example. However, it is also conceivable, by way of example, for the communication connections 201, 202 and 203 not to be exclusively wireless communication connections, for example at least one of the communication connections 201, 202 and/or 203 comprises at least one wired communication connection and at least one wireless communication connection.

FIG. 3a is a flowchart 300 that shows the steps of a method according to the invention by way of example. The steps shown in the flowchart 300 are performed and/or controlled by means in the control apparatus 100. By way of example, the steps are performed and/or controlled, at least in part, by the processor 101 of the control apparatus 100.

In a step 301, a piece of access authorisation information is obtained at the control apparatus 100. For example, the piece of access authorisation information is obtained in step 301 by the communication interface 104 or by the communication interface 108 and forwarded to the processor 101. For example, the piece of access authorisation information has been communicated to the control apparatus 100 by the delivery agent apparatus 20 via the communication connection 201 (cf. FIGS. 2a and 2b) or by the remote monitoring apparatus 30 via the communication connection 203 (cf. FIG. 2a).

The piece of access authorisation information authorises access for the delivery into the vehicle 10, for example, or includes pieces of information that authorise access for the delivery into the vehicle 10.

In a step 302, the unlocking of the door 11 of the vehicle 10 is caused, at least in part on the basis of the obtained piece of access authorisation information, by the control apparatus 100. For example, in step 302, the unlocking of the door 11 of the vehicle 10 is caused at least in part in response to the obtainment of the piece of access authorisation information in step 301.

For example, the processor 101 is configured to actuate the door lock 106 via vehicle interface 105 such that the door lock 106 is opened and the door 11 of the vehicle 10 is unlocked, so that the door 11 of the vehicle 10 can be opened by the delivery agent.

In a step 303, one or more pieces of delivery event information associated with a delivery event are obtained at the control apparatus 100.

As disclosed above, a delivery event is intended to be understood to mean, by way of example, an event that is initiated during the delivery process on the vehicle 10 and that is able to be sensed by appropriate sensing means. By way of example, a piece of delivery event information is intended to be understood as associated with a delivery event if the piece of delivery event information indicates that the delivery event has been sensed, for example has been sensed by appropriate sensing means. Preferably, the predetermined delivery events are initiated by an action by the delivery agent during the delivery process on the vehicle.

For example, the delivery event is opening of the door 11 of the vehicle 10 and/or the closing of the door 11 of the vehicle 10. For example, in step 303, the door opening sensor 107 senses that the door 11 of the vehicle 10 is opened (that is to say changes from the closed state to the open state) and/or closed (that is to say changes from the open state to the closed state), and produces one or more corresponding pieces of delivery event information. For example, the processor 101 receives these pieces of delivery event information in step 303 via vehicle interface 105.

In a step 304, the locking of the door of the vehicle is caused by the control apparatus only if the obtained pieces of delivery event information are associated with one or more predetermined delivery events. By way of example, the predetermined delivery event or the predetermined delivery events are chosen such that the initiation of the predetermined delivery event or of the predetermined delivery events has at least a high probability of allowing inference of the completion or the abortion of the delivery process on the vehicle 10.

For example, the processor 101 is configured to actuate the door lock 106 via vehicle interface 105, such that the door lock 106 is closed and the door 11 of the vehicle 10 is locked, only if the pieces of delivery event information obtained in step 303 are associated with one or more predetermined delivery events.

For example, the predetermined delivery event is the closing of the door 11 of the vehicle 10. For example, the processor 101 is configured to actuate the door lock 106 via vehicle interface 105, such that the door lock 106 is closed and the door 11 of the vehicle 10 is locked, only if the piece of delivery event information obtained in step 303 indicates that the door opening sensor 107 has sensed closing of the door 11 of the vehicle 10. However, it is also conceivable for multiple delivery events or delivery event combinations and the order thereof to be predetermined, for example the opening of the door 11 of the vehicle 10 and the subsequent closing of the door 11 of the vehicle 10. For example, the processor 101 is configured to actuate the door lock 106 via vehicle interface 105, such that the door lock 106 is closed and the door 11 of the vehicle 10 is locked, only if the pieces of delivery event information obtained in step 303 indicate that the door opening sensor 107 has sensed opening and subsequent closing of the door 11 of the vehicle 10.

FIG. 3b is a flowchart 400 that shows the steps of a method according to the invention by way of example. The steps shown in the flowchart 400 are performed and/or controlled by means in the control apparatus 100 and/or in the vehicle 10. By way of example, the steps are performed and/or controlled, at least in part, by the processor 101 of the control apparatus 100.

It is assumed by way of example below that for safety reasons various delivery events, delivery event combinations and the order thereof that are intended to result in locking of the door 11 of the vehicle 10 are predetermined. Thus, the locking of the door is intended to be caused when the door 11 is opened and subsequently closed or when the door 11 is opened and not closed in a predetermined time. In addition, the locking of the door is intended to be caused when the door 11 is unlocked and not opened in the predetermined time. The invention is not limited to these predetermined delivery events and the order thereof, however.

In a step 401, a piece of access authorisation information is obtained at the control apparatus 100. By way of example, step 401 corresponds to step 301 described above.

In a step 402, the obtained piece of access authorisation information is taken, at least in part, as a basis for deciding whether access can be granted. For example, in step 402, the processor 101 checks whether the obtained piece of access authorisation information authorises access.

As disclosed above, the piece of access authorisation information includes one or more access authorisation parameters, for example. This or these may be, by way of example, an (in particular explicit) identifier for the control apparatus 100 and/or the vehicle 10, an (in particular explicit) identifier for the piece of access authorisation information itself, pieces of temporal validity information (e.g. a delivery period), a spatial piece of validity information (e.g. a delivery area), an upper limit for the permitted uses of the piece of access authorisation information in order to gain access, and a piece of information concerning the extent to which access can be granted (that is to say, by way of example, whether all doors of the vehicle 10 can be opened, or just the door 11 of the vehicle 10, for example)

At least one predefined set (e.g. all, or just some) of the access authorisation parameters have respective reference pieces of information checked to determine whether they authorise access in each case. By way of example, the identifier for the control apparatus 100, as an access authorisation parameter, can have an identifier for the control apparatus 100, which is stored in the control apparatus 100, checked and, in the event of a match, it can be established that this access authorisation parameter authorises access.

By way of example, the pieces of temporal validity information, as access authorisation parameters, can have a piece of temporal information (e.g. date and time of day), obtained from a clock of the control apparatus 100, checked, for example such that a delivery period defined by the pieces of validity information must include the present time according to the clock of the control apparatus 100 in order for access to be able to be granted. By way of example, the delivery period may be a delivery period predetermined by the recipient of the shipment and/or the owner of the vehicle 10.

By way of example, the spatial pieces of validity information, as access authorisation parameters, can have a piece of spatial information (e.g. the present coordinates and/or the present position), obtained on the processor 101 from a positioning sensor of the control apparatus 100 and/or of the vehicle 10, checked, for example such that a delivery area (e.g. a radius around a delivery position) defined by the pieces of validity information must include the present coordinates and/or the present position of the control apparatus 100 and/or of the vehicle 10 in order for access to be able to be granted. By way of example, the delivery area may be a delivery area predetermined by the recipient of the shipment and/or the owner of the vehicle 10.

For example, access is thus granted if it has been established for at least one determined set of the access authorisation parameters that the respective reference piece of information of said access authorisation parameters authorises access in the control apparatus 100.

If, in step 402, it is decided that access can be granted, then the flowchart 400 is continued in step 403. Otherwise, the flowchart 400 ends.

In a step 403, the unlocking of the door 11 of the vehicle 10, for example as disclosed above for step 302, is caused.

In a step 404, a time measurement is started. By way of example, the processor 101 is configured to start the measurement of the time and to measure the time (e.g. by dint of a timer function and/or a clock function).

In a step 405, a check is performed to determine whether the opening of the door 11 has been sensed by the door opening sensor 107. For example, the processor 101 is configured to check whether an appropriate piece of delivery event information that indicates that the opening of the door 11 has been sensed by the door opening sensor 107 has been obtained on the processor 101 (e.g. from door opening sensor 107 via vehicle interface 105).

If step 405 establishes that the opening of the door 11 has been sensed by the door opening sensor 107 (e.g. that an appropriate piece of delivery event information that indicates that the opening of the door 11 has been sensed by the door opening sensor 107 has been obtained on the processor 101), then the flowchart is continued in step 406. Otherwise, the flowchart is continued in step 410.

In a step 406, the time measurement is restarted. For example, the processor 101 is configured to restart the measurement of the time (i.e. to reset the measured time) and to measure the time (e.g. by dint of a timer function and/or a clock function).

In a step 407, a check is performed to determine whether the closing of the door 11 has been sensed by the door opening sensor 107. For example, the processor 101 is configured to check whether an appropriate piece of delivery event information that indicates that the closing of the door 11 has been sensed by the door opening sensor 107 has been obtained on the processor 101 (e.g. from door opening sensor 107 via vehicle interface 105).

If step 407 establishes that the closing of the door 11 has been sensed by the door opening sensor 107 (e.g. that an appropriate piece of delivery event information that indicates that the closing of the door 11 has been sensed by the door opening sensor 107 has been obtained on the processor 101), then the flowchart is continued in a step 411 and the locking of the door 11 of the vehicle 10 is caused. Otherwise, the flowchart is continued in step 408.

In a step 408, a check is performed to determine whether the measured time (in this case e.g. the time since sensing of the opening of the door) exceeds a predetermined length of time. For example, the processor 101 is configured to check whether the measured time exceeds a predetermined length of time. As disclosed above, the predetermined length of time is, by way of example, an expected maximum length of time before the next delivery event (e.g. before closing of the door).

If step 408 establishes that the measured time exceeds a predetermined length of time, then the flowchart is continued in step 409. Otherwise, step 407 of the flowchart is repeated.

In a step 409, the closing of the door 11 of the vehicle 10 is caused. For example, the processor 101 is configured to actuate an electronically actuatable and motor-driven door opener and closer of the door 11 of the vehicle 10 via vehicle interface 105 such that the door 11 of the vehicle 10 is closed. If the door 11 of the vehicle 10 does not comprise such a door opener and closer, is alternatively possible, by way of example, for a visual and/or audible alarm to be initiated and/or for an appropriate piece of information to be sent to the remote monitoring apparatus 30 in order to prompt closing of the door by a person (e.g. the delivery agent, the owner or a passer-by). As soon as the door 11 of the vehicle 10 is closed, the flowchart is continued in step 411 and the locking of the door 11 of the vehicle 10 is caused.

If step 405 disclosed above does not establish that the opening of the door 11 has been sensed by the door opening sensor 107, then the flowchart is continued in step 410.

In a step 410, a check is performed to determine whether the measured time (in this case e.g. the time since causing of the unlocking of the door) exceeds a predetermined length of time. For example, the processor 101 is configured to check whether the measured time exceeds a predetermined length of time. As disclosed above, the predetermined length of time is, by way of example, an expected maximum length of time before the next delivery event (e.g. before opening of the door).

If step 410 establishes that the measured time exceeds a predetermined length of time, then the flowchart is continued in step 411 and the locking of the door 11 of the vehicle 10 is caused. Otherwise, step 405 of the flowchart is repeated.

In a step 411, the locking of the door 11 of the vehicle 10 is caused. By way of example, step 411 corresponds to step 304 described above. Subsequently, the flowchart 400 ends.

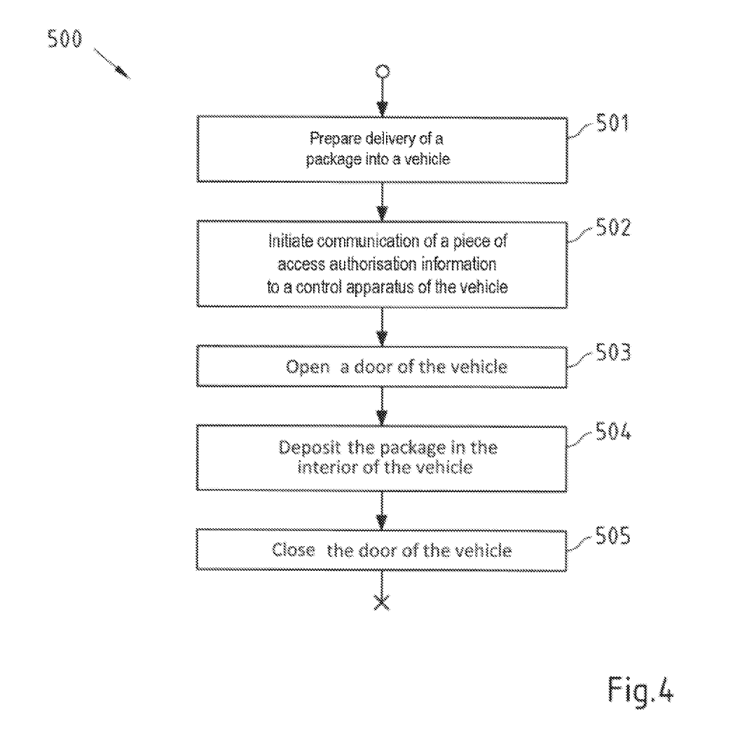

FIG. 4 is a flowchart 500 that shows the steps of an example of a use according to the invention. The steps shown in the flowchart 500 are performed by a delivery agent from a delivery service and described from the perspective of said delivery agent below. In the example shown in FIG. 4, the delivery agent wishes to open the door 11 of the vehicle 10 in order to place a package into the interior (e.g. the boot) of the vehicle 10 and hence to be able to deliver said package into the vehicle 10. In this example, it is assumed that the delivery agent uses a hand-held scanner (e.g. Honeywell's LXE-Tecton MX7) as delivery agent apparatus.

In a step 501, the delivery agent prepares the delivery of the package into the vehicle 10.

For example, the delivery agent scans a barcode that has been applied to the package using the hand-held scanner in step 501. As a result, the hand-held scanner can identify the package and retrieve the pieces of shipment information associated with the package, for example. By way of example, the pieces of shipment information include pieces of information about possible delivery of the package into the vehicle 10 whose owner is the recipient of the package. For example, a delivery position or a delivery area and a delivery period are displayed to the delivery agent, so that the delivery agent knows when and where the package can be delivered into the vehicle 10, for example. As disclosed above, the delivery position or the delivery area and the delivery period are predetermined by the recipient of the package and/or the owner of the vehicle 10, for example.

In a step 502, the delivery agent initiates the communication of a piece of access authorisation information to the control apparatus 100 of the vehicle 10.

For example, the user inputs an appropriate command on input means of the hand-held scanner, so that the hand-held scanner (e.g. the delivery agent apparatus 20 in FIG. 2a) communicates the piece of access authorisation information to the control apparatus 100 (e.g. uses communication connection 201 to send it to the communication interface 104 and/or 108). Alternatively, on the user input from the delivery agent, for example, the hand-held scanner can also communicate an access authorisation information request to a remote monitoring apparatus (e.g. remote monitoring apparatus 30 in FIG. 2b) (e.g. use communication connection 202 to send it to the remote monitoring apparatus 30) in order to prompt the remote monitoring apparatus to communicate the piece of access authorisation information to the control apparatus 100 (e.g. use communication connection 203 to send it to the communication interface 104 and/or 108).

As disclosed above for steps 301 and 302 of the flowchart 300 or 401 to 403 of the flowchart 400, for example, the control apparatus 100 obtains the piece of access authorisation information and causes the unlocking of the door 11 of the vehicle 10.

In a step 503, the delivery agent opens the door 11 of the vehicle 10. For example, the delivery agent opens the door 11 of the vehicle 10 before a time measurement started since the causing of the unlocking the door 11 of the vehicle 10, for example, exceeds a predetermined length of time (cf. e.g. steps 404, 405 and 410 of the flowchart 400).

In a step 504, the delivery agent places the package into the interior of the vehicle 10.

In a step 505, the delivery agent closes the door 11 of the vehicle 10. For example, the delivery agent closes the door 11 of the vehicle 10 before a time measurement (re)started since the opening of the door 11 of the vehicle 10, for example, exceeds a predetermined length of time (cf. e.g. steps 406 to 408 of the flowchart 400).

As described above, the locking of the door 11 of the vehicle 10 is subsequently caused by the control apparatus 100.

In the case of the flowchart 300, just the closing of the door 11 of the vehicle 10 in step 505, for example, may be a predetermined delivery event, so that the delivery agent can prompt the locking of the door 11 of the vehicle 10 by dint of closing of the door 11 of the vehicle 10 in step 505 (cf. steps 303 to 304 of the flowchart 300). In the case of the flowchart 400, the locking of the door 11 of the vehicle 10 by the delivery agent is prompted by the opening of the door 11 of the vehicle 10 in step 503 and the closing of the door 11 of the vehicle 10 in step 505 (cf. steps 405 to 409 and 411 of the flowchart 400).

The exemplary embodiments of the present invention that are described in this specification are also intended to be understood as disclosed in all combinations with one another. In particular, the description of a feature that an embodiment comprises is—unless explicitly explained to the contrary—also not intended to be understood, in the present case, to mean that the feature is indispensable or essential for the function of the exemplary embodiment. The sequence of the method steps outlined in this specification in the individual flowcharts is not imperative, and alternative sequences of the method steps are conceivable. The method steps can be implemented in different ways, and implementation in software (by dint of program instructions), hardware or a combination of the two is conceivable for implementing the method steps.

Terms used in the patent claims such as “comprise”, “have”, “contain”, “include” and the like do not exclude further elements or steps. The wording at least in pare covers both the “in part” case and the “completely” case. The wording “and/or” is intended to be understood to mean that both the alternative and the combination are intended to be disclosed, that is to say that “A and/or B” means “(A) or (B) or (A and B)”. Within the context of this specification, a plurality of units, persons or the like means multiple units, persons or the like. The use of the indefinite article does not exclude a plurality. A single device can carry out the functions of multiple units or devices cited in the patent claims. Reference symbols specified in the patent claims are not intended to be regarded as limitations for the means and steps employed.

1. A method for causing of unlocking and locking of at least one door of a vehicle for delivery of a shipment, particularly a package and/or a letter, into the vehicle, said method comprising:
obtaining a piece of access authorisation information at a control apparatus,
causing of the unlocking of the door of the vehicle, at least in part on the basis of the obtained piece of access authorisation information, by the control apparatus,
obtaining one or more pieces of delivery event information, associated with a delivery event, at the control apparatus,
causing of the locking of the door of the vehicle by the control apparatus only if the obtained pieces of delivery event information are associated with one or more predetermined delivery events.

2. The method according to claim 1, said method additionally comprising:
checking of whether the obtained pieces of delivery event information are associated with the predetermined delivery events.

3. The method according to claim 1, wherein at least one of the predetermined delivery events is opening and/or closing of the door, depositing of the shipment in an interior of the vehicle, exceeding of a predetermined duration of the delivery process since the causing of the unlocking of the door of the vehicle and/or since the obtaining of a piece of delivery event information, and/or a user input for completion of the delivery process by the delivery agent on a portable delivery agent apparatus.

4. The method according to claim 1, said method additionally comprising:
sensing of at least one of the predetermined delivery events.

5. The method according to claim 1, wherein the piece of access authorisation information and/or the pieces of delivery event information are received at the control apparatus via one or more wireless communication connections.

6. The method according to claim 5, wherein at least one of the wireless communication connections is a communication connection via a mobile radio network.

7. The method according to claim 5, wherein at least one of the wireless communication connections is a communication connection via a local radio network.

8. The method according to claim 1, said method additionally comprising:
deciding about whether access can be granted for the delivery into the vehicle, at least in part on the basis of the obtained piece of access authorisation information, and
causing of the unlocking of the door of the vehicle only if it has been decided that access can be granted.

9. The method according to claim 1, wherein the piece of access authorisation information authorises access for the delivery into the vehicle.

10. The method according to one of claim 1, wherein the piece of access authorisation information has a limited temporal and/or spatial validity and/or is valid for a limited number of accesses.

11. The method according to claim 1, wherein the door is a boot door of the vehicle, and/or wherein exclusively the boot door of the vehicle is unlocked.

12. The method according to claim 1, said method additionally comprising:
opening of the door and/or causing of the opening of the door, and/or
closing of the door and/or causing of the closing of the door.

13. The method according to claim 1, said method additionally comprising:
initiating the predetermined delivery events.

14. A non-transitory computer-readable medium having stored thereon a computer program that, when the computer program runs on a processor, causes the processor to perform and/or to control the method of claim 1.

15. A control apparatus, comprising:
means configured to perform the method according to claim 1 or comprising respective means for performing the steps of the method according to claim 1.

16. A vehicle, comprising:
at least one door,
locking means configured to lock and unlock the door, and
the control apparatus according to claim 15.

17. A system, comprising:
the vehicle according to claim 16, and
a portable delivery agent apparatus.

18. Use of the vehicle according to claim 16 and/or of a portable delivery agent apparatus for initiating one or more delivery events in order to prompt causing of the locking of a door of the vehicle according to claim 16.
